(19) United States
(12) Patent Application Publication
(10) Pub. No.: US 2024/0266905 A1
(43) Pub. Date: Aug. 8, 2024

(54) MOTOR UNIT

(71) Applicant: TOYOTA JIDOSHA KABUSHIKI KAISHA, Aichi (JP)

(72) Inventors: Ryuta HAYASHI, Aichi-ken (JP); Shotaro OKAMOTO, Toyota-shi (JP); Takashi KATAYAMA, Toyota-shi (JP); Sho ITO, Toyota-shi (JP)

(21) Appl. No.: 18/435,937

(22) Filed: Feb. 7, 2024

(30) Foreign Application Priority Data
Feb. 8, 2023 (JP) 2023-017906

(51) Int. Cl. H02K 5/22; B60K 1/00; B60L 15/00; H02K 5/20; H02K 7/116; H02K 9/19; H02K 11/33

(52) U.S. Cl. CPC H02K 5/225; B60K 1/00; B60L 15/007; H02K 5/203; H02K 7/116; H02K 9/19; H02K 11/33

(57) ABSTRACT

A drive device disclosed herein may include: a motor casing housing the electric motor; a gear connected to the electric motor; a gear casing housing the gear; an inverter electrically connected to the electric motor; an inverter casing housing the inverter; and a relay box including at least one relay and having a relay circuit configured to connect a charging inlet of the vehicle to a neutral point of the electric motor and to the inverter. The motor casing, the gear casing, and the inverter casing may be arranged along an axial direction extending parallel to a rotation axis of the electric motor, in an order of the gear casing, the motor casing, and the inverter casing.

### REFERENCE TO RELATED APPLICATIONS

This application claims priority from Japanese Patent Application No. 2023-017906 filed on Feb. 8, 2023. The entire content of the priority application is incorporated herein by reference.

### BACKGROUND ART

### Background

A drive device for a vehicle including: an electric motor that drives a wheel of the vehicle; a gear connected to the electric motor; an inverter electrically connected to the electric motor; and a casing is known. The casing of the drive device includes an equipment housing chamber housing the electric motor, a gear housing chamber housing the gear, and an inverter housing chamber housing the inverter. In the drive device, the inverter housing chamber is arranged relative to the gear housing chamber in a direction perpendicular to a rotation axis of the gear.

### DESCRIPTION

### SUMMARY

On a drive device for a vehicle, a relay circuit that connects an inverter to a charging inlet of the vehicle may be provided. Since the relay circuit is connected to a neutral point of the electric motor in addition to the inverter, wiring that connects the relay circuit to the drive device tends to be complex. As a result, a casing of the drive device including the relay circuit may become larger. The present disclosure provides a technique that can reduce a size of a casing of a drive device including a relay circuit.

A drive device disclosed herein may comprise: an electric motor configured to drive a wheel of a vehicle; a motor casing housing the electric motor; a gear connected to the electric motor; a gear casing housing the gear; an inverter electrically connected to the electric motor; an inverter casing housing the inverter; and a relay box including at least one relay and having a relay circuit configured to connect a charging inlet of the vehicle to a neutral point of the electric motor and to the inverter. The gear casing, the motor casing, and the inverter casing are arranged in this order along an axial direction extending parallel to a rotation axis of the electric motor. The relay box may be mounted to at least one of the motor casing, the gear casing, and the inverter casing and located relative at least to the inverter casing in a direction perpendicular to the rotation axis of the electric motor.

In the vehicle described above, the gear casing, the motor casing, and the inverter casing are arranged in this order along an axial direction extending parallel to a rotation axis of the electric motor. Further, the relay box is located relative to at least the inverter casing in the direction perpendicular to the rotation axis of the electric motor. Thus, the drive device may have a reduced casing size, especially with respect to the direction perpendicular to the rotation axis of the electric motor, as compared to a conventional technique in which an inverter casing is mounted to a gear casing in a direction perpendicular to the rotation axis of an electric motor.

Details and further improvements of the technique disclosed herein will be described in Detailed Description below.

### BRIEF DESCRIPTION OF DRAWINGS

FIG. 1 shows a plan view of an electric vehicle 100 on which a drive device 10 of an embodiment is mounted.

FIG. 2 shows a circuit diagram of the drive device 10 of the embodiment.

FIG. 3 shows a cross-sectional view along line III-III of FIG. 1.

FIG. 4 shows a cross-sectional view along line IV-IV of FIG. 3.

### EMBODIMENT

In one embodiment of the present technique, a connecting hole may be defined between the inverter casing and the relay box. In that case, an inverter connection circuit connecting the inverter and the relay circuit may pass through the connecting hole. According to this configuration, the inverter connection circuit can connect the inverter and the relay circuit through the connecting hole. Consequently, the drive device can have a reduced casing size of the casing as compared to a configuration in which the inverter connection circuit is routed on the outer surface of the inverter casing.

In one embodiment of the present technique, the relay box may be located relative to the motor casing, the gear casing, and the inverter casing in the direction perpendicular to the rotation axis of the electric motor. However, in another embodiment, for example, the relay box may be located relative to the inverter casing in the direction perpendicular to the rotation axis of the electric motor, or may be located relative to the inverter casing and gear casing in the direction perpendicular to the rotation axis of the electric motor.

In one embodiment of the present technique, the axial direction may extend along a horizontal direction. In that case, the relay box may be located above at least the inverter casing. However, in another embodiment, the relay box may be located below or behind at least the inverter casing.

In one embodiment of the present technique, the drive device may further comprise a cooling casing being located between the motor casing and the inverter casing and including a channel for supplying a heat medium to the inverter. According to this configuration, the cooling casing is arranged along the axial direction parallel to the rotation axis of the electric motor. Consequently, the casing can be downsized, especially with respect to the direction perpendicular to the rotation axis of the electric motor, as compared to a configuration in which the cooling casing is mounted to the inverter casing in the direction perpendicular to the rotation axis of the electric motor.

In one embodiment of the present technique, at least a part of a neutral point connection circuit connecting the neutral point of the electric motor and the relay circuit may be located in the cooling casing. In that case, at least the part of the neutral point connection circuit may be configured to be cooled by the heat medium in the cooling casing. According to such a configuration, the neutral point connection circuit can be cooled by the heat medium supplied to the inverter.

In one embodiment of the present technique, the neutral point connection circuit may extend from the motor casing to the inverter casing through the cooling casing. In that case, the neutral point connection circuit may extend from the inverter casing to the relay box. However, in another embodiment, the neutral point connection circuit may extend from the cooling casing to the relay box.

In one embodiment of the present technique, the electric motor may be a three-phase AC motor. In that case, the electric motor may be connected to the inverter via a U phase circuit, a V phase circuit, and a W phase circuit. Further, at least a part of the U phase circuit, at least a part of the V phase circuit and at least a part of the W phase circuit may be located in the cooling casing, and at least the part of the U phase circuit, at least the part of the V phase circuit and at least the part of the W phase circuit may be configured to be cooled by the heat medium in the cooling casing. According to this configuration, at least the part of the U phase circuit, at least the part of the V phase circuit and at least the part of the W phase circuit can be cooled by the heat medium supplied to the inverter.

In one embodiment of the present technique, a connecting hole may be defined between the inverter casing and the relay box. In that case, an inverter connection circuit connecting the inverter and the relay circuit and a neutral point connection circuit connecting the relay circuit and the neutral point of the electric motor may pass through the connecting hole. According to this configuration, both the inverter connection circuit and the neutral point connection circuit are integrated in the connecting hole. This allows the inverter and the neutral point of the electric motor to be connected to the relay circuit by a relatively simple structure.

In one embodiment of the present technique, a connecting hole may be defined between the inverter casing and the relay box. In that case, the relay circuit may further include a connector to which a circuit extending from a battery of the vehicle is connected. Further, an inverter connection circuit connecting the inverter and the relay circuit and a connector connection circuit connecting the inverter and the connector may pass through the connecting hole. According to this configuration, both the inverter connection circuit and the connector connection circuit are integrated in the connecting hole. This allows the inverter and the connector to be connected to the relay circuit by a relatively simple structure.

In one embodiment of the present technique, a connecting hole may be defined between the inverter casing and the relay box. In that case, the relay circuit may further include a connector to which a circuit extending from a battery of the vehicle is connected. Further, an inverter connection circuit connecting the inverter and the relay circuit, a neutral point connection circuit connecting the relay circuit and the neutral point of the electric motor, and a connector connection circuit connecting the inverter and the connector may pass through the connecting hole. According to this configuration, the inverter connection circuit, the neutral point connection circuit, and the connector connection circuit are all integrated in the connecting hole. This allows the inverter, the neutral point of the electric motor, and the connector to be connected to the relay circuit by a relatively simple structure.

### Embodiments

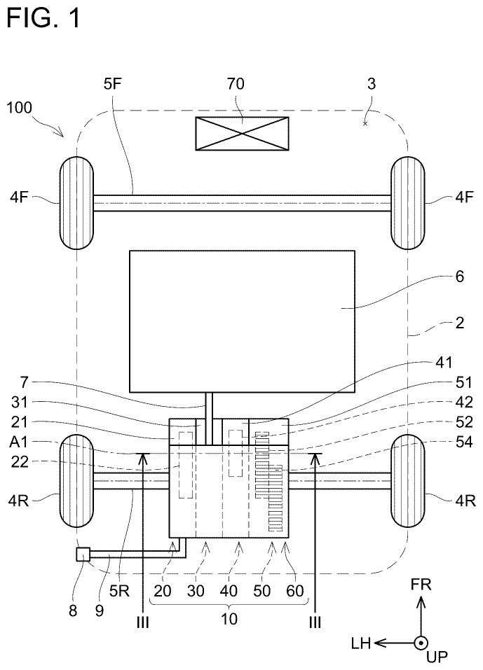

FIG. 1 shows a plan view of an electric vehicle 100 on which a drive device 10 of an embodiment is mounted. In addition to the drive device 10, the electric vehicle 100 includes a body 2, a front driveshaft 5F, a pair of front wheels 4F, a rear driveshaft 5R, a pair of rear wheels 4R, a battery pack 6, a charging inlet 8, and a radiator 70. For easier understanding, the body 2 of the electric vehicle 100 is shown by a dashed line in FIG. 1. The electric vehicle 100 herein includes a fuel cell vehicle as well as an electric vehicle. In the coordinate system in the drawings, FR indicates the front side of the electric vehicle 100, UP indicates the upper side of the electric vehicle 100, and LH indicates the left side of the electric vehicle 100. In the following, “up”, “down”, “left”, “right”, “front”, and “rear” are described based on the coordinate system in the drawings.

The pair of front wheels 4F is provided at opposite ends of the front driveshaft 5F, and the pair of rear wheels 4R is provided at opposite ends of the rear driveshaft 5R.

The drive device 10 is located below a rear seat (not shown) of the electric vehicle 100 and above a rear suspension member (not shown). In a variant, the drive device 10 may be positioned below a board constituting the bottom of a luggage space of the electric vehicle 100. The drive device 10 is configured to drive the pair of rear wheels 4R via the rear driveshaft 5R of the electric vehicle 100. The drive device 10 includes an inverter unit 20, a cooling unit 30, a motor unit 40, a gear unit 50, and a relay box 60.

The inverter unit 20 includes an inverter 22 and an inverter casing 21 that houses the inverter 22. The cooling unit 30 includes a cooling casing 31. The motor unit 40 includes a motor 42 and a motor casing 41 that houses the motor 42. The gear unit 50 includes a link gear 52, a differential gear 54, and a gear casing 51 that houses the gears 52 and 54. Each casing 21, 31, 41, 51 has a box shape that is relatively flat in a front-rear direction (i.e., in the up-down direction with respect to the page of FIG. 1). The casings 21, 31, 41, 51 is arranged in this order from the left along an axial direction parallel to a rotation axis A1 of the motor 42 (i.e., a width direction of the electric vehicle 100). In other words, when viewed along the axial direction parallel to the rotation axis A1 of the motor 42, the casings 21, 31, 41, 51 at least partially overlap one another. The inverter casing 21 is fixed to the adjacent cooling casing 31. The cooling casing 31 is fixed to the adjacent motor casing 41. The motor casing 41 is fixed to the adjacent gear casing 51. In a variant, the adjacent casings may not be fixed to each other. For example, another casing may be arranged between the inverter casing 21 and the cooling casing 31, or the inverter casing 21 and the cooling casing 31 may be axially spaced apart from each other.

The battery pack 6 is located below the body 2 of the electric vehicle 100. The battery pack 6 is configured to supply power to the drive device 10. Consequently, the drive device 10 drives the pair of rear wheels 4R. The battery pack 6 houses a plurality of rechargeable battery cells (not shown), such as lithium-ion cells, for example, and is configured for repetitive charge and discharge. The drive device 10 can also function as a generator for regenerative braking of the electric vehicle 100. The power generated by the drive device 10 is supplied to the battery pack 6 to charge the battery pack 6.

The charging inlet 8 is provided on the outer surface of the body 2 of the electric vehicle 100. The charging inlet 8 is a port for connecting the battery pack 6 to an external charging device. The charging inlet 8 is configured to be detachably attached to a connector of the external charging device.

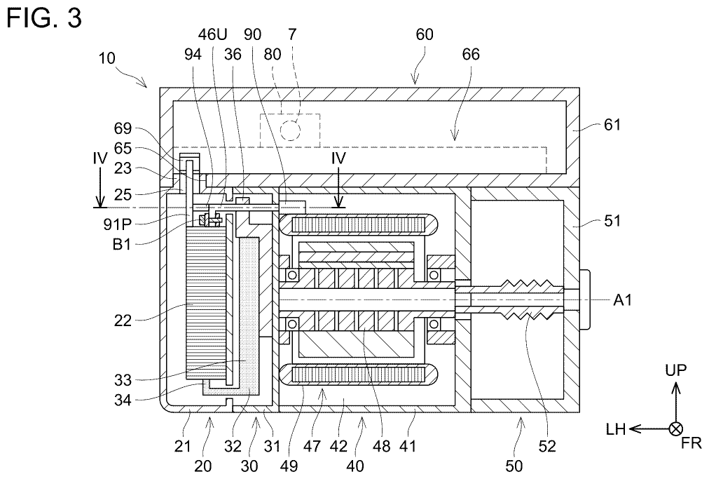

The radiator 70 is located at the front component 3 of the electric vehicle 100. The radiator 70 includes a plurality of hoses (not shown) extending in an up-down direction. A Long Life Coolant (LLC) circulates through the plurality of hoses. When the electric vehicle 100 is moving, wind passes through the plurality of hoses. This cools the LLC flowing through the plurality of hoses. Although not shown, the radiator 70 is connected to the cooling unit 30 of the drive device 10 by a heat transfer medium piping. The LLC is supplied from the radiator 70 to a channel 32 (see FIG. 3) formed in the cooling casing 31 of the cooling unit 30.

The relay box 60 includes a relay casing 61. The relay casing 61 has a box shape that is flat in a vehicle width direction (i.e., in the left-right direction with respect to the page of FIG. 1). The relay casing 61 of the relay box 60 houses a plurality of relay circuits to be described below. The relay casing 61 is detachably attached to each casing 21, 31, 41, 51 from above (i.e., into the page of FIG. 1). The relay casing 61 of the relay box 60 is located above each casing 21, 31, 41, 51. The relay circuits of the relay box 60 are connected to the battery pack 6 via the power cable 7. The relay circuits of the relay box 60 are connected to the charging inlet 8 via a charging cable 9.

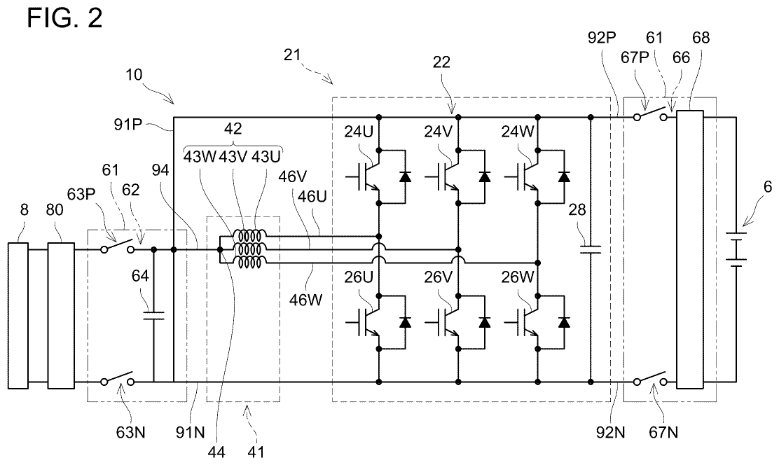

A circuit configuration of the drive device 10 will be described with reference to FIG. 2. In FIG. 2, the relay circuits housed in the relay casing 61 are enclosed by two-dot-chain lines, while the circuit housed in the motor casing 41 and the circuit housed in inverter casing 21 are enclosed by a dashed line. The relay box 60 houses a system main relay circuit 66 and a charging relay circuit 62 in the relay casing 61. In the drive device 10, the charging relay circuit 62, the motor 42, the inverter 22, and the system main relay circuit 66 are connected between the charging inlet 8 and the battery pack 6. Hereafter, the charging inlet 8 side may be described as “upstream side” and the battery pack 6 side as “downstream side”.

The charging relay circuit 62 is connected downstream of a charging connector 80 connected to the charging inlet 8. The charging relay circuit 62 is connected upstream of the motor 42 and the inverter 22. The charging relay circuit 62 is connected to the neutral point 44 of the motor 42 via the neutral point connection circuit 94. The charging relay circuit 62 is connected to the inverter 22 via inverter connection circuits 91P and 91N. In other words, the charging relay circuit 62 connects the charging inlet 8 to the neutral point 44 of the motor 42 and to the inverter 22.

The charging relay circuit 62 includes a pair of relays 63P, 63N and a charging smoothing capacitor 64. The pair of relays 63P, 63N is configured to electrically connect and disconnect the charging inlet 8, the motor 42, and the inverter 22. The charging smoothing capacitor 64 stabilizes the voltage of the circuits of the drive device 10 during charging.

The system main relay circuit 66 is located between the battery pack 6 and the inverter 22. The system main relay circuit 66 has a pair of relays 67P, 67N and a battery connector 68. The battery connector 68 is connected to a circuit extending from the battery pack 6. The pair of relays 67P and 67N is configured to electrically connect and disconnect the battery pack 6 and the inverter 22. The battery connector 68 of the system main relay circuit 66 is connected to the inverter 22 via connector connection circuits 92P and 92N.

The motor 42 is an electric motor configured to drive the rear wheels 4R of the electric vehicle 100 using power supplied from the battery pack 6. The motor 42 is a three-phase AC motor including a U phase coil 43U, a V phase coil 43V, and a W phase coil 43W. The upstream ends of the phase coils 43U, 43V, and 43W of the motor 42 are connected to each other at the neutral point 44. The downstream end of the U phase coil 43U of the motor 42 is connected to the inverter 22 via a U phase circuit 46U. Similarly, the downstream end of the V phase coil 43V is connected to the inverter 22 via a V phase circuit 46V, and the downstream end of the W phase coil 43W is connected to the inverter 22 via a W phase circuit 46W.

The inverter 22 is connected to the battery pack 6 via the system main relay circuit 66. The inverter 22 is a device configured to convert DC power from the battery pack 6 to AC power. The inverter 22 includes three upper switching elements 24U, 24V, 24W and three lower switching elements 26U, 26V, 26W. Hereafter, “switching element(s)” may be referred to as “SW element(s)”. The upper SW elements 24U, 24V, 24W are connected in series with the lower SW elements 26U, 26V, 26W, respectively.

The midpoint between the upper SW element 24U and the lower SW element 26U connected in series is electrically connected to the U phase coil 43U of the motor 42 via the U phase circuit 46U. As a result, the upper SW element 24U and the lower SW element 26U constitute a pair of upper and lower U phase arms that connects the U phase coil 43U of the motor 42 to the positive or negative terminal of the battery pack 6. Similarly, the upper SW element 24V and the lower SW element 26V connected in series constitute a pair of upper and lower V phase arms, and the midpoint therebetween is electrically connected to the V phase coil 43V of the motor 42 via the V phase circuit 46V. The upper SW element 24W and the lower SW element 26W connected in series constitute a pair of upper and lower W phase arms, and the midpoint therebetween is electrically connected to the W phase coil 43W of the motor 42 via the W phase circuit 46W. Operation of the three upper SW elements 24U, 24V, 24W, and the three lower SW elements 26U, 26V, 26W is controlled by a control unit (not shown) of the electric vehicle 100.

As shown in FIG. 2, the inverter casing 21 houses a traction smoothing capacitor 28 in addition to the inverter 22. The traction smoothing capacitor 28 stabilizes the voltage of the circuits of the drive device 10. The traction smoothing capacitor 28 is a filter capacitor to improve so-called EMC (Electromagnetic Compatibility).

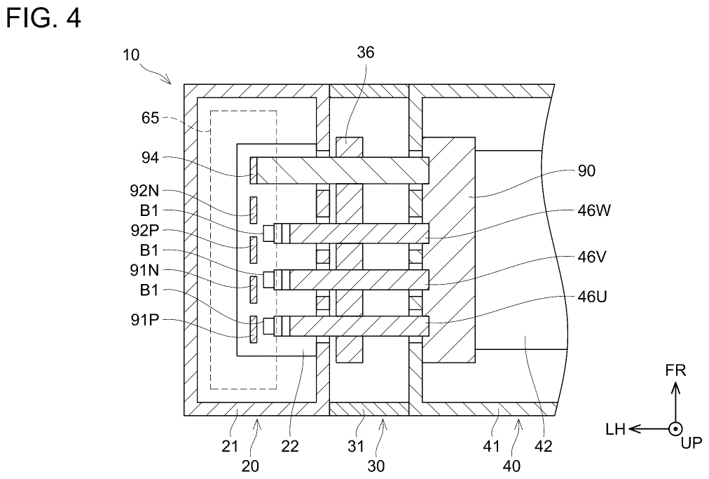

With reference to FIGS. 3 and 4, a circuit layout path in the drive device 10 will be described. FIG. 3 is a cross-sectional view along line III-III of FIG. 1. That is, FIG. 3 shows a cross-sectional view of the drive device 10 viewed from behind. FIG. 4 shows a cross-sectional view along line IV-IV of FIG. 3. That is, FIG. 4 shows a cross-sectional view of the drive device 10 viewed from above.

As shown in FIG. 3, the motor 42 housed in the motor casing 41 includes a rotor 48 and a stator 47. The rotor 48 extends in the horizontal direction along the rotation axis A1 of the motor 42. The rotor 48 passes through the right side wall of the motor casing 41 and is connected to the link gear 52 housed in the gear casing 51. The stator 47 includes a stator core and a stator coil 49 wrapped around the outer circumference of the stator core. The stator coil 49 of the stator 47 is constituted of the phase coils 43U, 43V, and 43W shown in FIG. 2. The motor casing 41 further houses a terminal block 90. The terminal block 90 connects the U phase coil 43U of the stator coil 49 to the U phase circuit 46U. Similarly, the terminal block 90 connects the V phase coil 43V to the V phase circuit 46V and the W phase coil 43W to the W phase circuit 46W. In addition, the terminal block 90 connects the neutral point connection circuit 94 to the neutral point 44 of the motor 42. As shown in FIGS. 3 and 4, each of the phase circuits 46U, 46U, 46W and the neutral point connection circuit 94 extend leftward from the terminal block 90 through the left side wall of the motor casing 41.

A cooling casing 31 is arranged on the left side of the motor casing 41. Within the cooling casing 31, a channel 32 and a heat dissipating member 36 are housed. The channel 32 is connected to the radiator 70 (see FIG. 1) of the electric vehicle 100 via a heat medium pipe. The channel 32 is thus supplied with the LLC 33 from the radiator 70. The channel 32 is connected to a pipe 34 that penetrates the right side wall of the inverter casing 21. The pipe 34 supplies the LLC 33 to the inverter 22 in the inverter casing 21. As a result, the inverter 22 is cooled by the LLC 33.

The heat dissipating member 36 is constituted of a metal with high thermal conductivity, e.g., aluminum. The heat dissipating member 36 extends in the up-down direction along the channel 32. The heat dissipating member 36 is in contact with the channel 32. Therefore, the heat dissipating member 36 is cooled by the LLC 33 in the channel 32. The heat dissipating member 36 extends further upward beyond the upper end of the channel 32.

The U phase circuit 46U passes through the right side wall of the cooling casing 31 and extends leftward within the cooling casing 31. In other words, at least a part of the U phase circuit 46U is located within the cooling casing 31. Similarly, as shown in FIG. 4, the V phase circuit 46V and the W phase circuit 46W also extend leftward within the cooling casing 31. Each of the phase circuits 46U, 46U, and 46W extends into the inverter casing 21 through the cooling casing 31. Further, in the cooling casing 31, a portion of each phase circuit 46U, 46U, 46W is covered by the heat dissipating member 36. Thereby, the heat of each phase circuit 46U, 46U, 46W is transferred to the heat dissipating member 36. As described above, in the drive device 10, each phase circuit 46U, 46U, 46W can be cooled by using the LLC 33 that cools the inverter 22. This can suppress an increase in the size of the drive device 10 as compared to, for example, a configuration including separate flow channel(s) for cooling the phase circuits 46U, 46U, 46W.

Similarly, at least a part of the neutral point connection circuit 94 is located within the cooling casing 31. Furthermore, the neutral point connection circuit 94 is also cooled by the heat dissipating member 36 in the cooling casing 31. Consequently, in the drive device 10, the neutral point connection circuit 94 can be cooled by using the LLC 33 that cools the inverter 22.

The U phase circuit 46U bends downward in the inverter casing 21 and is connected to the inverter 22 by a bolt B1. Similarly, the V phase circuit 46V is connected to the inverter 22 by the bolt B1, and the W phase circuit 46W is connected to the inverter 22 by the bolt B1.

As shown in FIG. 3, a connecting hole 65 is defined at the left end of the bottom wall of the relay casing 61. The connecting hole 65 opens the interior space of the relay casing 61 to the inverter casing 21. On the upper surface of the inverter casing 21, a pillar 23 extending upward toward the relay casing 61 is provided. The pillar 23 includes a through hole 25 extending in the up-down direction. The through hole 25 connects the inside and the outside of the inverter casing 21.

The pillar 23 of the inverter casing 21 is inserted into the connecting hole 65 of the relay casing 61. As a result, the inside of the relay casing 61 and the inside of the inverter casing 21 are connected. Consequently, the inverter connection circuit 91P is connected to the circuit connector 69 of the charging relay circuit 62 through the connecting hole 65. As shown in FIG. 4, the inverter connection circuits 91P, 91N, the connector connection circuits 92P, 92N, and the neutral point connection circuit 94 are connected to the circuits inside the relay casing 61 through the connecting hole 65. This can suppress an increase in the size of the drive device 10 as compared to the configuration in which each of the circuits 91P, 91N, 92P, 92N is routed on the outer surfaces of the inverter casing 21 and the relay casing 61.

Further, in the drive device 10 of the present embodiment, the inverter connection circuits 91P, 91N, the connector connection circuits 92P, 92N, and the neutral point connection circuit 94 are brought together and passed through the connecting hole 65. Therefore, the inverter 22 in the inverter casing 21 and the motor 42 in the motor casing 41 can be easily connected to the relay circuits 62 and 66 in the relay casing 61, as compared to the configuration in which the circuits 91P, 91N, 92P, 92N, 94 are separately routed. Furthermore, the circuits 91P, 91N, 92P, 92N, and 94 are so-called busbars and are self-supporting. Each of the circuits 91P, 91N, 92P, 92N, 94 is thereby inserted into the circuit connector 69 of its corresponding one of the relay circuits 62, 66 when the relay box 60 is mounted from above. This allows for easier connection as compared to a configuration which employs wiring as each circuit 91P, 91N, 92P, 92N, 94.

In the drive device 10 of the present embodiment, the rotation axis A1 of the motor 42 extends in the horizontal direction. Furthermore, in the drive device 10, the casings 21, 31, 41, 51 are arranged in this order from the left along the axial direction parallel to the rotation axis A1. Furthermore, the relay casing 61 of the relay box 60 is attached to each of the casings 21, 31, 41, 51. The relay casing 61 of the relay box 60 is located above each of the casings 21, 31, 41, 51. Thus, for example, as compared to a conventional technique in which the inverter casing 21 is mounted from above to the gear casing 51, the drive device 10 including the relay box 60 can be suppressed from increasing in size, especially with respect to the up-down direction. As a result, the height of the rear seat of the electric vehicle 100 can be set low, thus it is possible to make the passenger compartment of the electric vehicle 100 larger. In addition, when the drive device 10 is arranged below a board that constitutes the bottom of the luggage space of the electric vehicle 100, the luggage space can be made larger.

Further, as shown in FIG. 3, in the drive device 10 of the present embodiment, the length of the relay casing 61 is equal to the total length of the arranged casings 21, 31, 41, 51 with respect to the axial direction parallel to the rotation axis A1. This allows the drive device 10 to be mounted on the electric vehicle 100 in a space-efficient manner. As mentioned earlier, the relay casing 61 of the relay box 60 is detachably mounted to each of the casing 21, 31, 41, 51. Thus, for example, when a configuration in which the neutral point 44 of the motor 42 is not connected to the charging relay circuit 62 is employed, the size of the drive device 10 in the height direction can be easily reduced by removing the relay casing 61.

(Corresponding Relationships) The LLC33 is an example of “heat medium”. The battery connector 68 is an example of “connector”.

While the invention has been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(Variant 1) Each of the casings 21, 31, 41, 51 of the drive device 10 may be formed by a single casing molded in one piece.

(Variant 2) The drive device 10 may be arranged at the front component 3 of the electric vehicle 100. In that case, the drive device 10 may be configured to drive the front wheels 4F via the front driveshaft 5F.

(Variant 3) The connecting hole 65 may not be defined in the bottom wall of the relay casing 61 of the relay box 60. In that case, for example, the inverter connection circuits 91P, 91N may be routed along the outer surface of the inverter casing 21 to the relay casing 61.

(Variant 4) The size of the relay box 60 in the width direction is modified according to the number of elements arranged in the relay circuits housed in the relay casing 61, and the like. If the size of the relay casing 61 in the width direction is small, the relay box 60 may, for example, be mounted only to the inverter casing 21 from above. In that case, the relay box 60 may be positioned above only the inverter casing 21. In another variant, the relay box 60 may be for example mounted from the front to the inverter casing 21 and to the gear casing 51. Even in that case, the relay box 60 may be positioned above only the inverter casing 21 or above the inverter casing 21 and the motor casing 41. In yet another variant, the relay box 60 may be mounted only to the motor casing 41 from behind, for example. In that case, the relay box 60 may be positioned above, for example, the inverter casing 21 and gear casing 51. In other words, the direction in which the relay box 60 is mounted to each of the casings 21, 41, 51 and the direction in which the relay box 60 is positioned relative to each of the casings 21, 41, 51 may be the same or different.

(Variant 5) The relay box 60 may be positioned behind or below the inverter casing 21.

(Variant 6) The drive device 10 may not include the cooling unit 30. In that case, the LLC 33 may be supplied directly from the radiator 70 into the inverter casing 21.

(Variant 7) The neutral point connection circuit 94 may not pass through the cooling casing 31. In that case, the neutral point connection circuit 94 may be routed along the outer surface of the motor casing 41 and connected to the charging relay circuit 62 in the relay casing 61.

(Variant 8) The neutral point connection circuit 94 may penetrate the top wall of the cooling casing 31 and be connected to the charging relay circuit 62. In other words, the neutral point connection circuit 94 may not extend to the inverter casing 21.

(Variant 9) Each of the phase circuits 46U, 46V, 46W may not pass through the cooling casing 31. In that case, each of the phase circuits 46U, 46V, 46W may be routed along the outer surface of the motor casing 41 and connected to the charging relay circuit 62 in the relay casing 61.

(Variant 10) At least one of the inverter connection circuits 91P, 91N and the neutral point connection circuit 94 may not pass through the connecting hole 65. For example, the inverter connection circuits 91P and 91N may pass through the connecting hole 65 and the neutral point connection circuit 94 may pass through a different connecting hole or may be routed on the outer surface of the inverter casing 21 and connected to the charging relay circuit 62.

(Variant 11) The system main relay circuit 66 may not include the battery connector 68. In that case, the connector connection circuits 92P and 92N may not pass through the connecting hole 65.

The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A drive device, comprising:
an electric motor configured to drive a wheel of a vehicle;
a motor casing housing the electric motor;
a gear connected to the electric motor;
a gear casing housing the gear;
an inverter electrically connected to the electric motor;
an inverter casing housing the inverter; and
a relay box including at least one relay and having a relay circuit configured to connect a charging inlet of the vehicle to a neutral point of the electric motor and to the inverter,
wherein
the gear casing, the motor casing, and the inverter casing are arranged in this order along an axial direction extending parallel to a rotation axis of the electric motor, and
the relay box is mounted to at least one of the motor casing, the gear casing, and the inverter casing and located relative to at least the inverter casing in a direction perpendicular to the rotation axis of the electric motor.

2. The drive device according to claim 1, wherein
a connecting hole is defined between the inverter casing and the relay box, and
an inverter connection circuit connecting the inverter and the relay circuit passes through the connecting hole.

3. The drive device according to claim 1, wherein
the relay box is located relative to the motor casing, the gear casing, and the inverter casing in the direction perpendicular to the rotation axis of the electric motor.

4. The drive device according to claim 1, wherein
the axial direction extends along a horizontal direction, and
the relay box is located above at least the inverter casing.

5. The drive device according to claim 1, further comprising a cooling casing being located between the motor casing and the inverter casing and including a channel for supplying a heat medium to the inverter.

6. The drive device according to claim 5, wherein
at least a part of a neutral point connection circuit connecting the neutral point of the electric motor and the relay circuit is located in the cooling casing, and
at least the part of the neutral point connection circuit is configured to be cooled by the heat medium in the cooling casing.

7. The drive device according to claim 6, wherein
the neutral point connection circuit extends from the motor casing to the inverter casing through the cooling casing, and
the neutral point connection circuit extends from the inverter casing to the relay box.

8. The drive device according to claim 5, wherein
the electric motor is a three-phase AC motor,
the electric motor is connected to the inverter via a U phase circuit, a V phase circuit, and a W phase circuit,
at least a part of the U phase circuit, at least a part of the V phase circuit and at least a part of the W phase circuit are located in the cooling casing, and
at least the part of the U phase circuit, at least the part of the V phase circuit and at least the part of the W phase circuit are configured to be cooled by the heat medium in the cooling casing.

9. The drive device according to claim 1, wherein
a connecting hole is defined between the inverter casing and the relay box, and
an inverter connection circuit connecting the inverter and the relay circuit and a neutral point connection circuit connecting the relay circuit and the neutral point of the electric motor pass through the connecting hole.

10. The drive device according to claim 1, wherein
a connecting hole is defined between the inverter casing and the relay box,
the relay circuit further includes a connector to which a circuit extending from a battery of the vehicle is connected, and
an inverter connection circuit connecting the inverter and the relay circuit and a connector connection circuit connecting the inverter and the connector pass through the connecting hole.

11. The drive device according to claim 1, wherein
a connecting hole is defined between the inverter casing and the relay box,
the relay circuit further includes a connector to which a circuit extending from a battery of the vehicle is connected, and
an inverter connection circuit connecting the inverter and the relay circuit, a neutral point connection circuit connecting the relay circuit and the neutral point of the electric motor, and a connector connection circuit connecting the inverter and the connector pass through the connecting hole.
